(19) United States
(12) Patent Application Publication
(10) Pub. No.: US 2022/0079190 A1
(43) Pub. Date: Mar. 17, 2022

(54) Beverage Composition for Supporting General Health

(71) Applicants: RICHARD J. CHAMBERLIN, LAS VEGAS, NV (US); RONALD J. NORTON, ST. GEORGE, UT (US); CHI T. DUONG, LAS VEGAS, NV (US)

(72) Inventors: RICHARD J. CHAMBERLIN, LAS VEGAS, NV (US); RONALD J. NORTON, ST. GEORGE, UT (US); CHI T. DUONG, LAS VEGAS, NV (US)

(21) Appl. No.: 17/475,232

(22) Filed: Sep. 14, 2021

Related U.S. Application Data
(60) Provisional application No. 63/078,795, filed on Sep. 15, 2020.

(51) Int. Cl. A23L 2/66; A23L 33/105; A23L 33/15; A23L 33/17; A23L 33/115; A23L 33/16; A23L 2/56

(52) U.S. Cl. CPC A23L 2/66; A23L 33/105; A23L 33/15; A23L 2/56; A23L 33/115; A23L 33/16; A23L 33/17

(57) ABSTRACT

A beverage composition for supporting general health is a drinkable composition that enhances immune system unction, suppresses viral and pathogen propagation, and promotes general health for a user afflicted with ailments or medical condition that are not positively impacted by conventional treatments. The drinkable composition includes a quantity of nano-cannabinoids, a quantity of vitamin-and-mineral compound, a quantity of botanical compound, a quantity of enzyme compound, a quantity of hemp extract, a quantity of fruit-and-vegetable extract, a quantity of ancillary additives, and a quantity of liquid filler. The quantity of nano-cannabinoids, the quantity of vitamin-and-mineral compound, the quantity of botanical compound, the quantity of enzyme compound, the quantity of hemp extract, the quantity of fruit-and-vegetable extract, the quantity of ancillary additives, and the quantity of liquid filler are being homogenously mixed into a drinkable composition. The dosages and administration period for the drinkable composition may vary based on each user.

The current application claims a priority to the U.S. Provisional Patent application Ser. No. 63/078,795 filed on Sep. 15, 2020.

### FIELD OF THE INVENTION

The present invention generally relates to a composition that supports immune system function and suppresses pathogen propagation. More specifically, the present invention generally promotes health in patients afflicted with ailments or conditions that are unaffected by conventional treatments alone.

### BACKGROUND OF THE INVENTION

Cannabinoids, specifically referring to extracts and compounds derived from hemp and cannabis plants, is currently explored as a possible source of treatment for a broad range of ailments. Of particular note, the endocannabinoid system (ECS) offers promising new avenues to treatment of ailments via a targeted suppression of intercellular activity. Cannabinoid receptors on the surface of cells are sensitive to the presence of endocannabinoids—generally receiving such chemical signals in response to excessive activity indicative of some lack of internal homeostasis. It has been observed that targeted application of additional endocannabinoids, particularly in response to over-stimulation from injury or illness, may produce positive outcomes for patients in areas involving sleep, mood, memory, appetite, reproduction, and pain sensation. The broadness of these categories consequently indicates that the artificial regulation of the ECS may produce treatments for such ailments as kidney disease, Alzheimer's disease, autoimmune diseases, cardiovascular disease, and various chronic pain conditions. Further, control of the ECS may provide a means of suppressing or controlling inflammation, enabling the body to recover normally from otherwise non-healing wounds. However, the regulation and moderation of the ECS must be balanced against the natural internal balance of a patient's body; artificially introduced endocannabinoids alone cannot sustain and support beneficial patient outcomes. It is therefore proposed that a combined formulation of bioavailable endocannabinoids and essential supporting compounds may provide greater benefit to a patient than either composition alone.

### BRIEF DESCRIPTION OF THE DRAWINGS

FIG. 1 is a block diagram showing a drinkable composition.

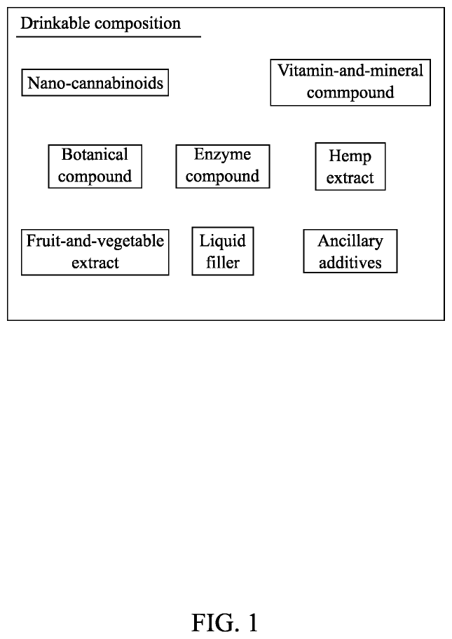

FIG. 2 is a block diagram showing an alternate embodiment of a drinkable composition with a quantity of Tellicherry peppercorns.

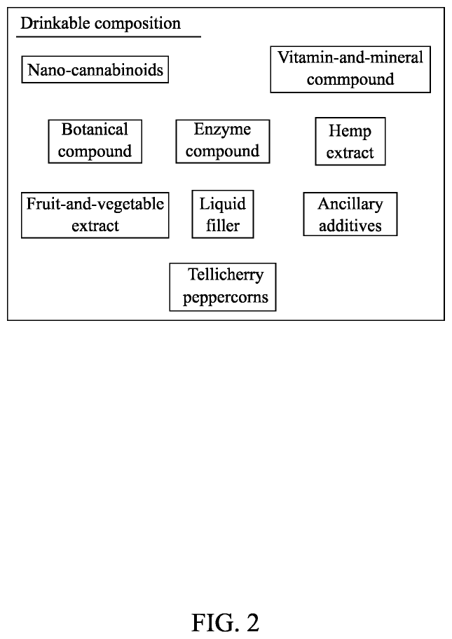

FIG. 3 is a block diagram showing a preferred group of nano-cannabinoids.

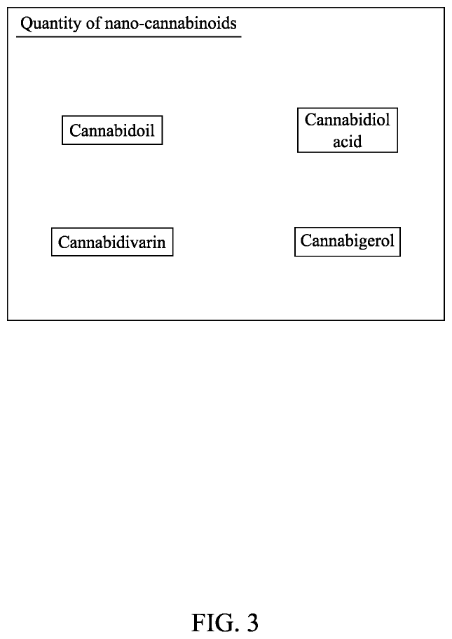

FIG. 4 is a block diagram showing a preferred group of vitamin-and-mineral compounds.

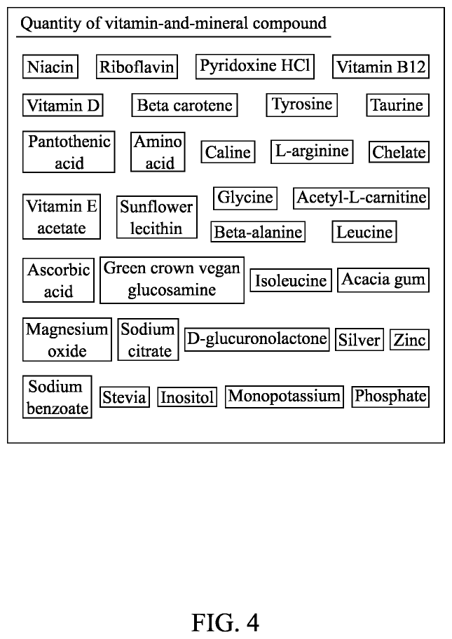

FIG. 5 is a block diagram showing a preferred group of botanical compounds.

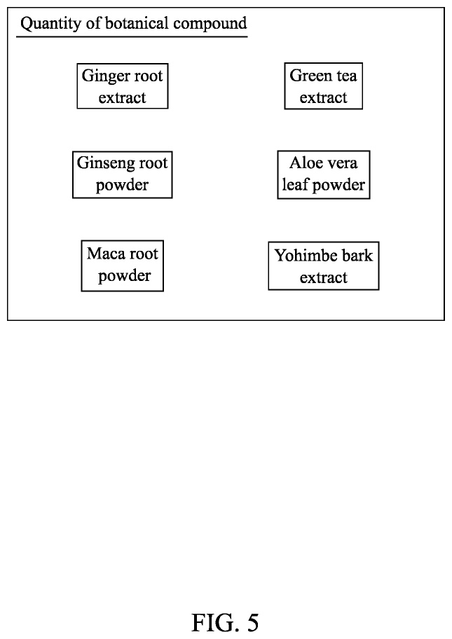

FIG. 6 is a block diagram showing a preferred group of enzyme compounds.

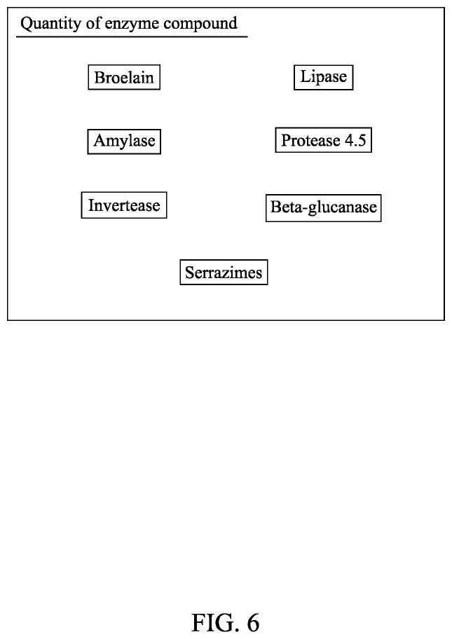

FIG. 7 is a block diagram showing a preferred group of hemp extract.

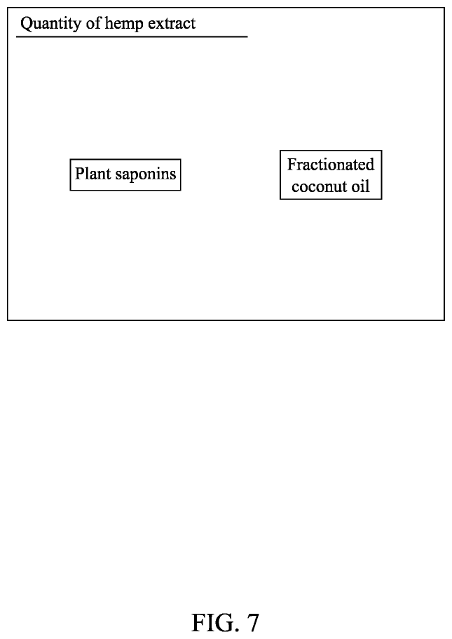

FIG. 8 is a block diagram showing a preferred group of fruit-and-vegetable extract.

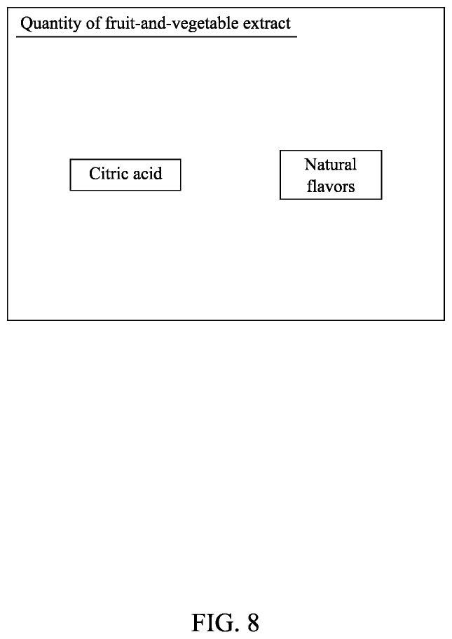

FIG. 9 is a block diagram showing a preferred group of ancillary additives.

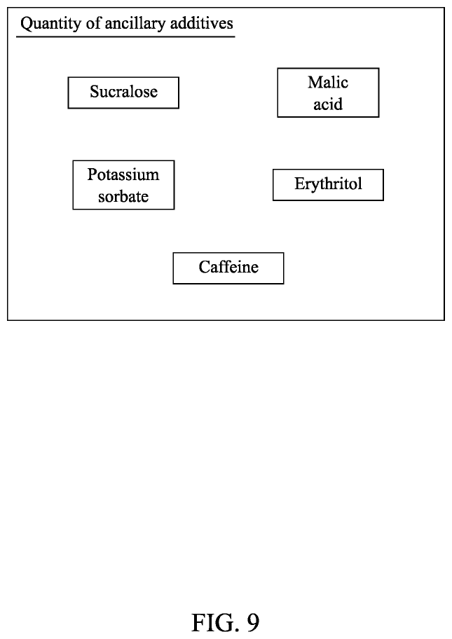

FIG. 10 is a block diagram showing a preferred group of liquid filler.

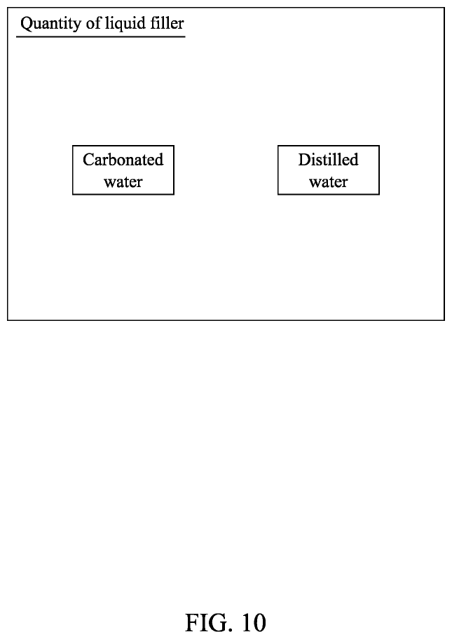

### DETAIL DESCRIPTIONS OF THE INVENTION

All illustrations of the drawings are for the purpose of describing selected versions of the present invention and are not intended to limit the scope of the present invention.

The present invention is a beverage composition for supporting general health. The present invention supports and improves the natural function of the immune system of a user. The present invention is rendered to individual particles approximately 25-nanometer in diameter, improving short-term bioavailability in conjunction with additional ingredients. Specific interactions with the endocannabinoid system (ECS) are proposed to improve the wound healing of a user, aid in viral suppression, and promote general health and wellbeing over an administration period. The administration period may vary depending on the health issue and the health condition of the user. Likewise, the administered volumes may be adjusted to account for the body weight, the age, and other physical factors of a user. The present invention may be applied as a preventative measure against a variety of ailments, including most pathogens. The present invention comprises a quantity of nano-cannabinoids, a quantity of vitamin-and-mineral compound, a quantity of botanical compound, a quantity of enzyme compound, a quantity of hemp extract, a quantity of fruit-and-vegetable extract, a quantity of ancillary additives, and a quantity of liquid filler. The quantity of nano-cannabinoids offers greater bioavailability due to a nanoparticulate arrangement of encapsulated CBD molecules. Each particulate element is contemplated to be delivered in conjunction with a combination of the quantity of vitamin-and-mineral compound, the quantity of botanical compound, the quantity of enzyme compound, the quantity of hemp extract, the quantity of fruit-and-vegetable extract, the quantity of ancillary additives, and the quantity of liquid filler in order to increase the efficacy of the drinkable composition. The quantity of vitamin-and-mineral compound, the quantity of botanical compound, and the quantity of fruit-and-vegetable extract boost the immune system of the user and facilitate the improvement of the health of the user. The quantity of enzyme compound aids in the activation of the present invention with the body of the user. The quantity of hemp extract and the quantity of fruit-and-vegetable extract aids the relief of symptoms causing the user pain and discomfort. The quantity of ancillary additives allows the quantity of nano-cannabinoids, the quantity of vitamin- and mineral compound, the quantity of botanical compound, the quantity of enzyme compound, the quantity of hemp extract, and the quantity of fruit-and-vegetable extract to bind together and be absorbed to the body accordingly. The quantity of liquid filler allows a user to ingest the quantity of nano-cannabinoids, the quantity of vitamin- and mineral compound, the quantity of botanical compound, the quantity of enzyme compound, the quantity of hemp extract, the quantity of fruit-and-vegetable extract, and the quantity of ancillary additives smoothly. The quantity of nano-cannabinoids, the quantity of vitamin-and-mineral compound, the quantity of botanical compound, the quantity of enzyme compound, the quantity of hemp extract, the quantity of fruit-and-vegetable extract, the quantity of ancillary additives, and the quantity of liquid filler are being homogenously mixed into a drinkable composition. The drinkable composition aids in the full recoveries of a user with stage IV mantle cell lymphoma condition, severe viral infection, pneumonia, terminal HIV/AIDS, stage IV Kaposi sarcoma tumors and lesions, terminal stage IV metastasized breast condition, virulent and debilitating virus condition, stage IV brain condition, severe viral infection, a partially collapsed lung, acute kidney renal condition, ischemic ulcers, gangrene condition, stage III throat/tonsil squamous cell condition, chronic sciatic-related pain and discomfort, severe long-haul viral infection, stage IV pancreatic condition, stage IV lung condition metastasized to liver and bones, chronic and uncontrollable cough condition, stage III Merkel cell carcinoma condition, prostate condition which has metastasized to bones, prostate condition, brain tumors behind an eye, methicillin-resistant Staphylococcus aureus (MRSA), hepatitis C, severe liver condition, stage IV metastasized colon condition, candida infection, lung condition, shingles, psoriasis, ringworm, skin infections, Crohn's condition, endometriosis, facial scars, food poisoning, non-healing wound, severe sinus infection, headaches, periodontal inflammation, tooth and gum problems, the flu, the common cold, upper respirator infection, periodontal infection, severe burns, severe scars, liver condition, chronic influenza, covid-19, covid-19 (delta variant), and so on.

In order to optimize the potency of the present invention, the aforementioned compositional components are mixed at specific preferred ratios. Thus, the quantity of nano-cannabinoids is approximately 2 to 5 percentage by weight (wt. %) of the drinkable composition. In reference to the aforementioned compositional proportion for the nano-cannabinoids, the term “approximately” preferably means within an error range of up to ±1 wt. %. Furthermore, the quantity of vitamin-and-mineral compound is approximately 4 to 5 wt. % of the drinkable composition. In reference to the aforementioned compositional proportion for the vitamin- and mineral compound, the term “approximately” preferably means within an error range of up to ±1 wt. %. Furthermore, the quantity of botanical compound is approximately 2 to 3 wt. % of the drinkable composition. In reference to the aforementioned compositional proportion for the botanical compound, the term “approximately” preferably means within an error range of up to ±1 wt. %. Furthermore, the quantity of enzyme compound is approximately 0.5 to 1 wt. % of the drinkable composition. In reference to the aforementioned compositional proportion for the enzyme compound, the term “approximately” preferably means within an error range of up to ±0.5 wt. %. Furthermore, the quantity of hemp extract is approximately 4 to 5 wt. % of the drinkable composition. In reference to the aforementioned compositional proportion for the hemp extract, the term “approximately” preferably means within an error range of up to ±1 wt. %. Furthermore, the quantity of fruit-and-vegetable extract is approximately 2 to 3 wt. % of the drinkable composition. In reference to the aforementioned compositional proportion for the fruit-and-vegetable extract, the term “approximately” preferably means within an error range of up to ±1 wt. %. Furthermore, the quantity of ancillary additives is approximately 1.5 to 2 wt. % of the drinkable composition. In reference to the aforementioned compositional proportion for the ancillary additives, the term “approximately” preferably means within an error range of up to ±0.5 wt. %. Furthermore, the quantity of liquid filler is approximately 76 to 84 wt. % of the drinkable composition. In reference to the aforementioned compositional proportion for the liquid filler, the term “approximately” preferably means within an error range of up to ±1 wt. %.

In order to target specific diseases, pains, infections, and ailments, the quantity of nano-cannabinoids is selected from a group consisting of cannabidiol (CBD), cannabidiol acid (CBDA), cannabidivarin (CBDV), cannabigerol (CBG), and combinations thereof. Furthermore, the quantity of vitamin-and-mineral compound is selected from a group consisting of niacin, pantothenic acid, riboflavin, pyridoxine HCl, vitamin E acetate, vitamin B12, vitamin D, beta carotene, ascorbic acid, tyrosine, taurine, caline, L-arginine, amino acid chelate, glycine, green crown vegan glucosamine, sunflower lecithin, acetyl-L-carnitine, beta-alanine, leucine, isoleucine valine, acacia gum, D-glucuronolactone, magnesium oxide, sodium citrate, silver, zinc, stevia, sodium benzoate, inositol, monopotassium phosphate, and combinations thereof. Furthermore, the quantity of quantity of botanical compound is selected from a group consisting of ginger root extract, green tea extract, ginseng root powder, aloe vera leaf powder, maca root powder, yohimbe bark extract, and combinations thereof. Furthermore, the quantity of enzyme compound is selected from a group consisting of bromelain, lipase, amylase, protease 4.5, invertease, beta-glucanase, serrazimes, and combinations thereof. Furthermore, the quantity of hemp extract is selected from a group consisting of plant saponins, fractionated coconut oil, and combinations thereof. Furthermore, the quantity of fruit-and-vegetable extract is selected from a group consisting of citric acid, natural flavors, and combinations thereof. Furthermore, the quantity of ancillary additives is selected from a group consisting of a sucralose, malic acid, potassium sorbate, erythritol, caffeine and combinations thereof. Furthermore, the quantity of liquid filler is selected from a group consisting of distilled water, carbonated water, and combinations thereof.

The present invention may further comprise a quantity of gnawed Tellicherry peppercorns, which is also used to optimize the potency of the present invention. More specifically, the quantity of gnawed Tellicherry peppercorns aids a user with covid-19 (delta variant). Thus, the quantity of gnawed Tellicherry peppercorns is further heterogeneously mixed into the drinkable composition, thereby relieving a user suffering from fever, chills, cough, shortness of breath, difficulty breathing, low energy, fatigue, muscle aches, headache, loss of taste and smell, sore throat, congestion, runny nose, tightness of the chest, nausea, vomiting, and diarrhea as a result of having covid-19 (delta variant).

In the preferred embodiment of the present invention, the drinkable composition is contained in a 16-ounce bottle. In one embodiment of the present invention, a bottle may have 500 milligrams (mg) of CBD. In a second embodiment of the present invention, a bottle may have 1,000 mg of CBD. More specifically, the drinkable composition contains 0% tetrahydrocannabinol (THC). It is recommended that the bottle is gently shaken, and the drinkable composition is served ice cold. A user may be initially directed to consume approximately 1 fluid ounce, twice a day, for an administration period of 8 days. A supplementary course with an additional administration period of 8 days may be recommended if the user fails to improve or additional symptoms emerge. The initial symptoms may be counteracted by a user consuming approximately 3 fluid ounces, twice a day, for an administration period of 4 to 8 days as a more intensive course. It is understood that this more intensive course may supplement conventional medical treatment, including hospitalization in an intensive care setting. For an extreme regimen, a user consumes 4 fluid ounces, twice a day, for an administration period of 4 to 8 days. The administration may be adjusted to account for contemporaneous conventional treatment programs as needed.

Although the invention has been explained in relation to its preferred embodiment, it is to be understood that many other possible modifications and variations can be made without departing from the spirit and scope of the invention as hereinafter claimed.

What is claimed is:

1. A beverage composition for supporting general health comprising:
a quantity of nano-cannabinoids;
a quantity of vitamin-and-mineral compound;
a quantity of botanical compound;
a quantity of enzyme compound;
a quantity of hemp extract;
a quantity of fruit-and-vegetable extract;
a quantity of ancillary additives;
a quantity of liquid filler; and,
the quantity of nano-cannabinoids, the quantity of vitamin-and-mineral compound, the quantity of botanical compound, the quantity of enzyme compound, the quantity of hemp extract, the quantity of fruit-and-vegetable extract, the quantity of ancillary additives, and the quantity of liquid filler being homogeneously mixed into a drinkable composition.

2. The beverage composition for supporting general health as claimed in claim 1, wherein the quantity of nano-cannabinoids is approximately 2 to 5 percentage by weight (wt. %) of the drinkable composition.

3. The beverage composition for supporting general health as claimed in claim 1, wherein the quantity of vitamin-and-mineral compound is approximately 4 to 5 wt. % of the drinkable composition.

4. The beverage composition for supporting general health as claimed in claim 1, wherein the quantity of botanical compound is approximately 2 to 3 wt. % of the drinkable composition.

5. The beverage composition for supporting general health as claimed in claim 1, wherein the quantity of enzyme compound is approximately 0.5 to 1 wt. % of the drinkable composition.

6. The beverage composition for supporting general health as claimed in claim 1, wherein the quantity of hemp extract is approximately 4 to 5 wt. % of the drinkable composition.

7. The beverage composition for supporting general health as claimed in claim 1, wherein the quantity of fruit-and-vegetable extract is approximately 2 to 3 wt. % of the drinkable composition.

8. The beverage composition for supporting general health as claimed in claim 1, wherein the quantity of ancillary additives is approximately 1.5 to 2 wt. % of the drinkable composition.

9. The beverage composition for supporting general health as claimed in claim 1, wherein the quantity of liquid filler is approximately 76 to 84 wt. % of the drinkable composition.

10. The beverage composition for supporting general health as claimed in claim 1, wherein the quantity of nano-cannabinoids is selected from a group consisting of: cannabidiol (CBD), cannabidiol acid (CBDA), cannabidivarin (CBDV), cannabigerol (CBG), and combinations thereof.

11. The beverage composition for supporting general health as claimed in claim 1, wherein the quantity of vitamin-and-mineral compound is selected from a group consisting of: niacin, pantothenic acid, riboflavin, pyridoxine HCl, vitamin E acetate, vitamin B12, vitamin D, beta carotene, ascorbic acid, tyrosine, taurine, caline, L-arginine, amino acid chelate, glycine, green crown vegan glucosamine, sunflower lecithin, acetyl-L-carnitine, beta-alanine, leucine, isoleucine valine, acacia gum, D-glucuronolactone, magnesium oxide, sodium citrate, silver, zinc, stevia, sodium benzoate, inositol, monopotassium phosphate, and combinations thereof.

12. The beverage composition for supporting general health as claimed in claim 1, wherein the quantity of botanical compound is selected from a group consisting of: ginger root extract, green tea extract, ginseng root powder, aloe vera leaf powder, maca root powder, yohimbe bark extract, and combinations thereof.

13. The beverage composition for supporting general health as claimed in claim 1, wherein the quantity of enzyme compound is selected from a group consisting of: broelain, lipase, amylase, protease 4.5, invertease, beta-glucanase, serrazimes, and combinations thereof.

14. The beverage composition for supporting general health as claimed in claim 1, wherein the quantity of hemp extract is selected from a group consisting of: plant saponins, fractionated coconut oil, and combinations thereof.

15. The beverage composition for supporting general health as claimed in claim 1, wherein the quantity of fruit-and-vegetable extract is selected from a group consisting of: citric acid, natural flavors, and combinations thereof.

16. The beverage composition for supporting general health as claimed in claim 1, wherein the quantity of ancillary additives is selected from a group consisting of: a sucralose, malic acid, potassium sorbate, erythritol, caffeine and combinations thereof.

17. The beverage composition for supporting general health as claimed in claim 1, wherein the quantity of liquid filler is selected from a group consisting of: distilled water, carbonated water, and combinations thereof.

18. The beverage composition for supporting general health as claimed in claim 1 comprising:
a quantity of gnawed Tellicherry peppercorns; and,
the quantity of gnawed Tellicherry peppercorns being heterogeneously mixed into the drinkable composition.
